(19) United States
(12) Patent Application Publication
(10) Pub. No.: US 2004/0206437 A1
(43) Pub. Date: Oct. 21, 2004

(54) Tire/wheel assembly

(76) Inventors: Ichiro Akiyama, Hiratsuka-shi (JP); Hiroshi Yamauchi, Toyota-shi (JP); Yasuji Akiyoshi, Nagoya-shi (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 10/806,208

(22) Filed: Mar. 23, 2004

(30) Foreign Application Priority Data
Mar. 25, 2003 (JP) JP2003-081756

(51) Int. Cl. B60C 5/22; B60C 19/00

(52) U.S. Cl. 152/341.1; 152/339.1; 152/342.1; 152/340.1; 152/450

(57) ABSTRACT

Disclosed is a tire/wheel assembly capable of reducing air column resonance sound without deteriorating uniformity or damaging rim assembling performance. In this tire/wheel assembly, an annular tube, an outer sectional area of which is nonuniform in a tire circumferential direction, is arranged in a closed space formed between a pneumatic tire and a wheel.

### BACKGROUND OF THE INVENTION

The present invention relates to a tire/wheel assembly in which a closed space is formed while a wheel is fit to a pneumatic tire, and more particularly, to a tire/wheel assembly in which air column resonance sound is reduced without deteriorating uniformity or damaging rim assembling performance.

As countermeasures against noise caused by air column resonance of an automobile wheel, there has-been proposed a technique for shortening resonance time at a single frequency by changing a sectional shape of a closed space formed between a pneumatic tire and a wheel in a tire circumferential direction to reduce noise caused by the air column resonance (e.g., Japanese Patent Application Laid-Open No. 2001-113902). In this case, in order to change the sectional shape of the closed space in the tire circumferential direction, a proper member is fixed to a rim outer peripheral surface of a wheel or an inner surface of a tire.

However, when a member for changing the sectional shape of the closed space is arranged on the tire inner surface, there is a problem that uniformity is deteriorated due to weight or rigidity of the member. Meanwhile, when the member for changing the sectional shape of the closed space is arranged on the rim outer peripheral surface of the wheel, a size limitation based on a rim shape standard restricts a sectional area changing rate of the closed space. Consequently, it is impossible to sufficiently reduce the air column resonance sound. Besides, rim assembling performance is damaged when a large member, which is not compliant with the rim shape standard, is fit to the rim outer peripheral surface of the wheel.

### SUMMARY OF THE INVENTION

An object of the present invention is to provide a tire/wheel assembly capable of reducing air column resonance sound without deteriorating uniformity or damaging rim assembling performance.

In order to achieve the object, the tire/wheel assembly of the present invention is characterized in that an annular tube, an outer sectional area of which is nonuniform in a tire circumferential direction, is arranged in a closed space formed between a pneumatic tire and a wheel.

The arrangement of the annular tube, the outer sectional area of which is nonuniform in the tire circumferential direction, in the closed space between the pneumatic tire and the wheel increase a sectional area changing rate of the closed space without deteriorating uniformity. Accordingly, it is possible to effectively reduce the air column resonance sound. Herein, a sectional area changing rate of the closed space by the tube is preferably 5.0% or higher. Additionally, even when the sectional area changing rate of the closed space is large, the tube is flattened during rim assembling, the tire is filled with air after the rim assembling, and lastly the tube is filled with air. Accordingly, the air column resonance sound can be reduced without damaging rim assembling performance. Therefore, the wheel is preferably provided with a valve for adjusting internal pressure of the pneumatic tire and a valve for adjusting internal pressure of the tube.

### BRIEF DESCRIPTION OF THE DRAWINGS

FIG. 1 is a side view showing a tire/wheel assembly according to an embodiment of the present invention.

FIG. 2 is a side view showing a tube arranged in a closed space of the tire/wheel assembly of the present invention.

FIG. 3 is a sectional view taken along an III-III line of FIG. 1.

FIG. 4 is a sectional view taken along a IV-IV line of FIG. 1.

### DETAILED DESCRIPTION OF THE PREFERRED EMBODIMENT

Hereinafter, the constitution of the present invention will be described in detail with reference to the accompanying drawings.

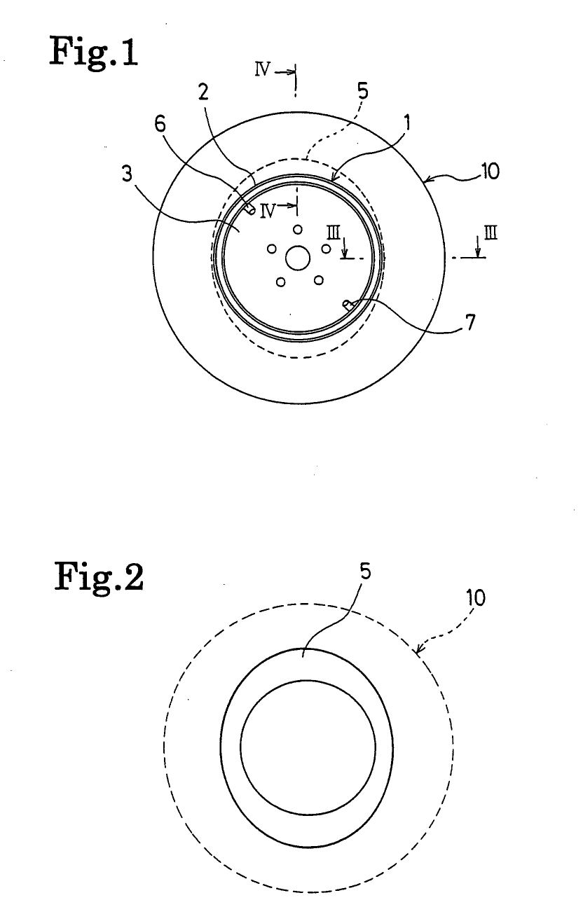

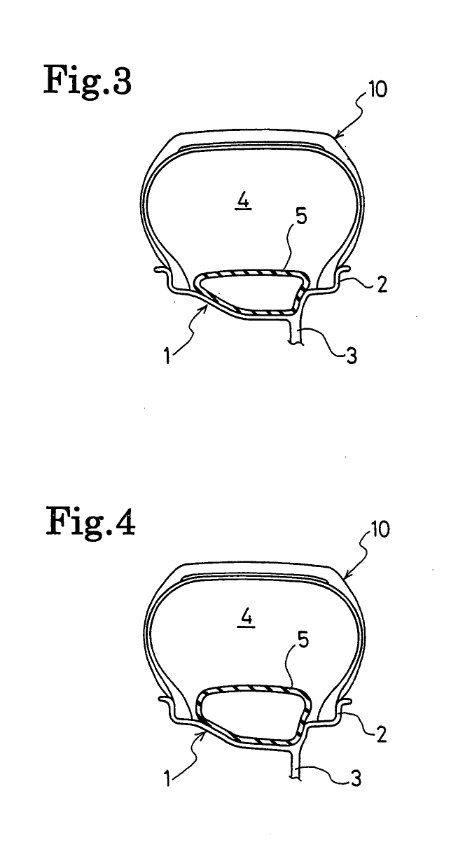

FIG. 1 is a side view showing a tire/wheel assembly (wheel) according to an embodiment of the present invention. FIG. 2 is a side view showing a tube arranged in a closed space of the tire/wheel assembly. FIG. 3 is a sectional view taken along an III-III line of FIG. 1. FIG. 4 is a sectional view taken along a IV-IV line of FIG. 1. As shown in FIGS. 1 to 4, the tire/wheel assembly comprises a wheel 1 and a pneumatic tire 10. The wheel 1 includes a rim 2 for fixing the tire 10, and a disc 3 for connecting the rim 2 to an axle (not shown). When the pneumatic tire 10 is fixed to the wheel 1, a closed space 4 is formed therebetween.

An annular tube 5, an outer sectional area of which is nonuniform in a tire circumferential direction, is arranged in the closed space 4. That is, the outer sectional area of the tube 5 at a tire meridian section is changed along the tire circumferential direction. This tube 5 is in contact with an outer peripheral surface of the rim 2 of the wheel 1, but not with an inner surface of the pneumatic tire 10. There is no particular limitation on materials of the tube 5, but rubber is preferably used. Examples of rubber include natural rubber (NR), isoprene rubber (IR), styrene-butadiene rubber (SBR), butadiene rubber (BR), and butyl rubber (IIR). As a matter of course, it is possible for the rubber to contain an additive such as a filler, a vulcanizing agent, a vulcanization accelerator, a softener, or an antioxidant as appropriate, and a reinforcing agent such as silica or carbon black or a reinforcing cord made of resin or steel can be used.

The wheel 1 includes a valve 6 for adjusting internal pressure of the pneumatic tire 10 and a valve 7 for adjusting internal pressure of the tube 5. The valve 6 for the tire penetrates the rim 2 and communicates with the closed space 4. Meanwhile, the valve 7 for the tube penetrates the rim 2 and communicates with the tube 5. Thus, the pneumatic tire 10 and the tube 5 can be individually filled air to control the internal pressure. In consideration of uniformity, it is preferred that the valve 6 for the tire and the valve 7 for the tube be arranged in opposing positions in the tire circumferential direction.

In the tire/wheel assembly, the tube 5 is flattened when the pneumatic tire 10 is assembled to the rim 2 of the wheel 1. Accordingly, rim assembling work can be smoothly carried out. After the rim assembling, the tire 10 is filled with air through the valve 6 for the tire, and lastly the tube 5 is filled with air.

When the annular tube 5, the outer sectional area of which is nonuniform in the tire circumferential direction, is arranged in the closed space 4 between the pneumatic tire 10 and the wheel 1 as described above, an air column resonance frequency of the closed space 4 is changed with rotation of the wheel, thereby reducing air column resonance sound. Moreover, the tube 5 prevents deterioration of uniformity or rim assembling performance even when a sectional area changing rate of the closed space 4 is increased. That is, uniformity is deteriorated due to weight or rigidity of a solid member when the member having a sectional area equal to that of the tube 5 is fixed to the tire inner surface. Rim assembling performance is deteriorated when the solid member having the sectional area equal to that of the tube 5 is fixed to the rim outer peripheral surface.

It is preferred that a sectional area changing rate of the closed space 4 by the tube 5 be set to 5.0% or higher. When this sectional area changing rate is lower than 5.0%, a reduction effect of air column resonance sound becomes unsatisfactory. There is no particular limitation on an upper value of the sectional area changing rate. However, an upper limit is preferably set to 25% because an excessively large rate leads to deterioration of uniformity. The sectional area changing rate is represented by (A2−A1)/(A−A1)×100%, where A is a sectional area of the closed space 4 when the tube 5 does not exist, A1 is a minimum value (see FIG. 3) of an outer sectional area of the tube 5, and A2 is a maximum value (see FIG. 4) of an outer sectional area of the tube 5.

The preferred embodiment of the present invention has been described in detail hereinbefore. However, it should be understood that various changes, modifications and substitutions can be made without departing from the spirit and scope of the present invention defined in the appended claims.

### EXAMPLE

Tire/wheel assemblies of conventional examples 1 to 4 and the embodiment, which comprise pneumatic tires of 185/70R14 in tire size and wheels of 14×5·½ JJ in rim size, were manufactured. The conventional example 1 uses a normal pneumatic tire. In the conventional example 2, a member, an outer sectional area of which is nonuniform in a tire circumferential direction, is stuck to a tire inner surface, and a sectional area changing rate of a closed space is set to 2.0%. In the conventional example 3, a member, an outer sectional area of which is nonuniform in a tire circumferential direction, is stuck to a tire inner surface, and a sectional area changing rate of a closed space is set to 4.0%. In the conventional example 4, a member, an outer sectional area of which is nonuniform in a tire circumferential direction, is stuck to a rim outer peripheral surface, and a sectional area changing rate of a closed space is set to 2.0%. Meanwhile, in the embodiment, an annular tube, an outer sectional area of which is nonuniform in a tire peripheral direction, is arranged in a closed space formed between the tire and the wheel, and a sectional area changing rate of the closed space is set to 6.0%.

These five kinds of tire/wheel assemblies were evaluated in terms of air column resonance sound and uniformity by a measuring method below. The results are shown in Table 1.

Air Column Resonance Sound:

For each tire/wheel assembly, air column resonance sound (dB) was measured by a microphone installed in a position at the driver's ear on a driver seat window side in a vehicle compartment when driving a passenger car of 1800 cc displacement on a rough road surface at a speed of 50 km/h with air pressure set to 220 kPa. Results of evaluation are represented by relative values while the conventional example 1 is set as a reference (±0.0). A positive value means larger air column resonance sound, and a negative value means smaller air column resonance sound.

Uniformity:

For each tire/wheel assembly, tractive force variation (TFV) was measured at a speed of 100 km/h to compare secondary components thereof. Inverse numbers of the measured values were used in the evaluation, and results of evaluation were represented by indexes while the conventional example 1 is set to 100. A larger index value means better uniformity.

TABLE 1

| | Conventional | Conventional | Conventional | Conventional | |
|---|---|---|---|---|---|
| | example 1 | example 2 | example 3 | example 4 | Embodiment |
| Member arrangement | — | Tire inner | Tire inner | Rim outer | Tube |
| form in closed | | surface | surface | peripheral | |
| space | | | | surface | |
| Sectional area | 0.0 | 2.0 | 4.0 | 2.0 | 6.0 |
| changing rate (%) | | | | | |
| Air column | ±0.0 | −1.0 | −2.0 | −1.0 | −3.0 |
| resonance sound | | | | | |
| (dB) | | | | | |
| Uniformity (index) | 100 | 100 | 60 | 100 | 100 |

As apparent from the Table 1, in the tire/wheel assembly of the embodiment, uniformity is high and a reduction effect of air column resonance sound is large. In the conventional examples 2 and 4, a reduction effect of air column resonance sound is unsatisfactory although uniformity is high. In the conventional example 3, deterioration of uniformity is prominent although a reduction effect of air column resonance sound is observed.

According to the present invention, since the annular tube, the outer sectional area of which is nonuniform in the tire circumferential direction, is arranged in the closed space formed between the pneumatic tire and the wheel, it is possible to reduce air column resonance sound without deteriorating uniformity or damaging rim assembling performance.

What is claimed is:

1. A tire/wheel assembly, comprising an annular tube arranged in a closed space formed between a pneumatic tire and a wheel, an outer sectional area of the tube being nonuniform in a tire circumferential direction.

2. The tire/wheel assembly according to claim 1, wherein the wheel is provided with a valve for adjusting internal pressure of the pneumatic tire, and a valve for adjusting internal pressure of the tube.

3. The tire/wheel assembly according to claim 2, wherein the valve for adjusting the internal pressure of the pneumatic tire and the valve for adjusting the internal pressure of the tube are arranged in opposing positions at the wheel.

4. The tire/wheel assembly according to claim 1, wherein a sectional area changing rate of the closed space by the tube is 5.0% or higher.

5. The tire/wheel assembly according to claim 2, wherein a sectional area changing rate of the closed space by the tube is 5.0% or higher.

6. The tire/wheel assembly according to claim 3, wherein a sectional area changing rate of the closed space by the tube is 5.0% or higher.
